(19) United States
(12) Patent Application Publication
(10) Pub. No.: US 2025/0247218 A1
(43) Pub. Date: Jul. 31, 2025

(54) SYSTEM FOR SECURE ROUTING IN A QUANTUM KEY DISTRIBUTION NETWORK

(71) Applicant: Rohde & Schwarz GmbH & Co. KG, Munich (DE)

(72) Inventor: Peter HOROSCHENKOFF, Taufkirchen (DE)

(21) Appl. No.: 18/980,843

(22) Filed: Dec. 13, 2024

(30) Foreign Application Priority Data
Jan. 31, 2024 (DE) 10 2024 102 662.6

(51) Int. Cl. H04L 9/08; H04L 9/14

(52) U.S. Cl. CPC H04L 9/0855; H04L 9/14

(57) ABSTRACT

The disclosure relates to a system for secure routing in a quantum key distribution, QKD, network. The system comprises: a network controller node which comprises a QKD module and a key management system, KMS, module; and at least two routing nodes which comprise a respective QKD module, and which are configured for forwarding information from a number of network entities in the QKD network; wherein the network controller node is configured to establish a secure communication connection with the at least two routing nodes via a key management system, KMS, layer or a network layer; wherein the network controller node is configured to receive management information from the routing nodes via the secure communication connection and to establish global knowledge based on the received management information; and wherein the network controller node is configured to distribute relevant parts of the global knowledge to the respective routing nodes via the secure communication connection; wherein the secure communication connection is encrypted using keys provided by the QKD modules.

### RELATED APPLICATION

This application claims the benefit of priority from German Patent Application No. 10 2024 102 662.6, filed on Jan. 31, 2024, the contents of which are incorporated herein by reference in its entirety.

### TECHNICAL FIELD

The present disclosure relates to a system for secure routing in a quantum key distribution (QKD) network.

### BACKGROUND

Quantum key distribution (QKD) is a secure form of encryption that allows data to be transmitted using a mechanism that implicitly detects eavesdropping. In QKD, a shared random key is used to encrypt and decrypt messages between two parties. Any attempt by a third party to eavesdrop on the key is detected due to the quantum mechanical principle of disturbing a system when measuring it.

A QKD network is a communication network that uses QKD for encrypting communication in the network. However, a communication in a QKD network often requires sending information on the configuration of the QKD network itself, such as network topography and “network status information”, to a network instance via less secure communication. This can cause problems for the confidentiality, availability, integrity, and authenticity of the QKD network.

### SUMMARY

Thus, it is an objective to provide an improved system for secure routing in a QKD network which avoids the above-mentioned disadvantages.

The objective is achieved by the solution provided in the enclosed independent claims. Advantageous implementations of the present disclosure are further defined in the dependent claims.

According to a first aspect, the present disclosure relates to a system for secure routing in a quantum key distribution (QKD) network. The system comprises: a network controller node which comprises a QKD module and a key management system (KMS) module; at least two routing nodes which comprise a respective QKD module, and which are configured for forwarding information from a number of network entities in the QKD network; wherein the network controller node is configured to establish a secure communication connection with the at least two routing nodes via a key management system (KMS) layer or a network layer; wherein the network controller node is configured to receive management information from the routing nodes via the secure communication connection and to establish global knowledge of the QKD network based on the received management information, wherein the network controller node is configured to distribute relevant parts of the global knowledge to the respective routing nodes via the secure communication connection; wherein the secure communication connection is encrypted using keys provided by the QKD modules.

This achieves the advantage that global information on the QKD network (as well as management information from the routing nodes) is only exchanged via secured communication in the QKD network using keys provided by the QKD modules. This enhances the confidentiality, availability, integrity, and authenticity of the QKD network.

Furthermore, a network load can be reduced if the network controller node only instructs certain routing nodes to forward information (via the relevant parts of the global knowledge).

The system can form a secure network topology using the QKD principle.

The routing nodes can use the received parts of the global knowledge to establish a routing path for forwarding the information. The information can comprise data packets which are forwarded from one network entity or party to another (e.g., messages which are communicated from one network party to another). The network entities can be other routing nodes in the QKD network.

In general, a QKD network (QKDN) can comprises: a quantum layer, a key management (KM) layer (or key management system layer, KMS layer), an application/service/network layer, and a control- & management (CM) layer.

The quantum layer can comprises the QKD modules establishing a point to point connection via a QKD protocol.

The CM layer can comprise the network controller node which is e.g. collecting management information, monitoring the network health, and distributing parts or all of the collected global knowledge to the nodes.

The KMS layer can be configured for key distribution between all QKD network nodes and/or can maintain a quantum key pool. The key management/KMS layer can comprises KMS modules establishing a secure connection between two nodes. It can realize a key distribution scheme and provide keys (one or more) to SAEs (Secure Application Entities).

If the KMS layer is overloaded, the routing nodes can use their initial routing table for forwarding information from network entities. In addition or alternatively, in this case the network layer (instead of the KMS layer) can be used for transmitting the network information (e.g., global knowledge). But messaging via the network layer could have a downside for confidentiality, thus balance network performance is balanced versus confidentiality when making this choice. In general, designing QKD networks is a trade-off between security and performance.

The network layer can be a layer of a user network, e.g. an application layer, a service layer or a user network management layer. The application/service/network layer can be used the by the KMS established keys to securely connect to devices (e.g., SAEs).

The QKD network can be formed by at least three routing nodes and one network controller node. A routing node can be any node besides the network controller node (often also named trusted nodes and access nodes).

The QKD modules can be hardware and/or software modules which implement a QKD protocol and/or other functions for key generation and/or distribution, also referred to as “key growth”.

For instance, the keys for establishing the secure connection between the network controller node and one of the routing nodes can be established by the QKD module of the network controller node and/or the routing node communicating with the network controller node.

In an embodiment, if the secure communication connection is established via the network layer, the keys are established from the KMS layer which receives the keys from the QKD modules.

For instance, if the secure communication connection is established via the KMS layer, it is encrypted using keys provided by the QKD modules; and if the secure communication connection is established via the network layer, it is encrypted using keys distributed via the KMS layer and provided by the QKD modules. Hereby, the QKD modules can be the respective modules of the communicating nodes.

In an embodiment, the network controller node and/or the at least two routing nodes comprise a respective KMS module which is configured to interact with the KMS layer. For instance, the KMS module is configured to perform key management in the KMS layer.

The KMS module can be implemented as a key management system and/or key management functionality in the network controller node and/or the two routing nodes.

In an embodiment, the respective KMS module of the routing nodes is configured to determine if a data packet was generated by itself or received from another node, and not to decrypt the data packet if the data packet was generated by itself.

The KMS module can be a functional module for performing key management in the key management layer. Further, it can be responsible for routing and delivering the secure key(s) via secured, i.e. encrypted, channels. It can thus enable a secure connection between two distant parties.

In an embodiment, the network controller node and/or the at least two routing nodes are configured to establish a new key from the network layer if they detect that there is an insufficient number of keys.

In an embodiment, the network controller node and/or the at least two routing nodes comprise a respective secure application entity (SAE) which is configured to interact with the network layer.

The SAE can be any device able to receive secure keys and establishing a secure communication. For instance, the SAE is a network encryptor module.

For example, the management information comprises status information and/or channel information from the routing nodes and all its interacting devices.

In an embodiment, the global knowledge comprises an optimal network topology and/or configuration for a routing operation in the QKD network and the actual status/health of the whole network. For example, the routing operation refers to a routing of a number of data packets between two entities in the network.

In an embodiment, the at least two routing nodes comprise a respective initial routing table which is updated and/or adapted based on the received relevant parts of the global knowledge.

The management information can comprise information on the initial routing table.

According to a second aspect, the present disclosure relates to a method for secure routing in a quantum key distribution (QKD) network. The method comprises the steps of: providing a network controller node which comprises a QKD module and a key management system (KMS) module; establishing a secure communication connection between the network controller node and at least two routing nodes via a KMS layer or a network layer, wherein the at least two routing nodes comprise a respective QKD module and are configured for forwarding information from a number of network entities in the QKD network; receiving, at the network controller node, management information from the routing nodes via the secure communication connection; establishing global knowledge of the QKD network based on the received management information, and distributing relevant parts of the global knowledge from the network controller node to the respective routing nodes via the secure communication connection; wherein the secure communication connection is encrypted using keys provided by the QKD modules.

### BRIEF DESCRIPTION OF THE DRAWINGS

The above described aspects and implementations are explained in the following description of embodiments with respect to the enclosed drawings:

FIG. 1 shows a schematic diagram of a system for secure routing in a QKD network according to an embodiment;

FIG. 2 shows a flow diagram of a method for secure routing in a QKD network according to an embodiment;

FIG. 3 shows an establishment of a secure communication between two nodes according to an embodiment; and

FIG. 4 shows different implementations of a control-and management layer for QKDN according to an embodiment.

### DETAILED DESCRIPTION OF EMBODIMENT

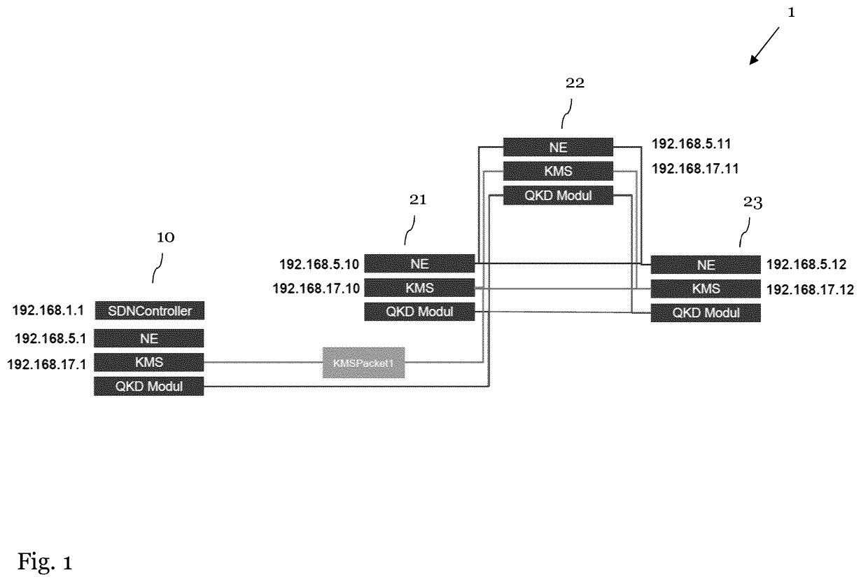

FIG. 1 shows a schematic diagram of a system 1 for secure routing in a QKD network according to an embodiment. The system 1 comprises a network controller node 10 which comprises a QKD module and a KMS module; and at least two routing nodes 21-23 which comprise a respective QKD module, and which are configured for forwarding information from a number of network entities in the QKD network.

The network controller node 10 is configured to establish a secure communication connection with the at least two routing nodes 21-23 via a KMS layer or a network layer. The network controller node 10 is configured to receive management information from the routing nodes 21-23 via the secure communication connection and to establish global knowledge of the QKD network based on the received management information. The network controller node 10 is further configured to distribute relevant parts of the global knowledge to the respective routing nodes 21-23 via the secure communication connection; wherein the secure communication connection is encrypted using keys provided by the QKD modules.

This enhances the confidentiality, availability, integrity, and authenticity of the QKD network, because information on the network status and topology is only exchanged in an encrypted manner and not publicly available. This brings the advantage that even an eavesdropper positioned right in front of the network controller will not receive any more information than between any other network connections. Further, the eavesdropper might not even know that she is positioned between the network controller and a network node. In contrast, in a scheme, where every node would have a dedicated, unencrypted channel to the network controller, an eavesdropper in front of the network controller would have the same global knowledge of the QKDN as the network controller (e.g. the amount of nodes in the network, the status of the links/nodes, etc.).

In particular, the communication via the key management layer can be encrypted via keys distributed by the QKD modules. In case of a communication via the network layer, the keys can be established from the key management layer, which has the keys from the QKD modules.

For instance, the at least two routing nodes 21-23 can comprise a respective initial routing table which is updated and/or adapted based on the received relevant parts of the global knowledge. The global knowledge can comprise an optimal network topology and/or configuration for a routing operation in the QKD network.

While FIG. 1 shows three routing nodes 21-23, this only serves as an example, and any number of routing nodes equal or larger than two is possible.

For example, the relevant parts of the global knowledge can comprise parts of the optimal network topology relevant for the respective routing nodes 21-23 and/or instructions to the respective routing nodes 21-23 on how to adapt their routing tables. In this way, the routing nodes 21-23 can use the received parts of the global knowledge to establish a routing path for data packets, e.g. from and/or to other network entities or parties.

For example, the management information which is forwarded from the routing nodes 21-23 to the network controller node 10 can comprises status information on the network and/or channel information from the routing nodes. Furthermore, the management information can comprise information on the routing table of the respective routing nodes 21-23.

The network controller node 10 can be attached to the KMS module as SAE (Secure Application Entity) or to a device in the network layer (e.g. a network encryptor) that is connected to the KMS module as SAE.

A network controller node 10 having global knowledge and distributes this knowledge to the nodes can be referred to as: “SDN-Controller”. Further, security measurements between the controller and the KMS module/network encryptor node may be provided.

In this way, the network controller thus works (as the management traffic is relayed by the KMS layer or network layer) similar to a jump-server/proxy. An “architecture” like this is also used in so-called demilitarized zones (DMZ).

In addition to the network controller node 10, also the at least two routing nodes 21-23 can comprises a respective KMS module (“KMS” in FIG. 1). Each KMS module can be configured to interface and/or interact with the KMS layer of the QKD network. For instance, the KMS modules can be configured to perform key management in the KMS layer.

The KMS module can be a functional module for performing key management in the key management layer. Further, it can be responsible for routing and delivering the secure key(s) via secured, i.e. encrypted, channels. It can thus enable a secure connection between two distant parties. A KMS module can also calculate optimal routes based on the previous distributed knowledge by the network controller node.

For instance, a respective KMS module of the routing nodes 21-23 is configured to determine if a data packet received by the node 21-23 is generated by itself or received from another node, wherein the KMS module decides not to decrypt the data packet if it is generated by itself.

The KMS layer can be configured for key distribution between all QKD network nodes and/or can maintain a quantum key pool. The KMS layer may also be referred to as key management layer.

The network layer can be a layer of a user network, e.g. a service layer or user network management layer.

The network controller node 10 and/or the at least two routing nodes comprise a respective secure application entities (SAE). For instance, the SAEs can be network encryptor modules (“NE” in FIG. 1) The encryptor module can be configured to send and/or receive messages via the network layer.

The QKD network can further comprise a service and/or communication layer for key usage by the SAEs or more specifically network encryptor modules.

The QKD network can further comprise a quantum layer which is configured for point to point key generation by QKD protocols and/or a control & management layer which is configured to monitor the network health and manage the network in an optimal way.

In an example, the network controller node 10 and/or the at least two routing nodes 21-23 can be configured to establish a new key from the network layer if they detect that there is an insufficient number of keys.

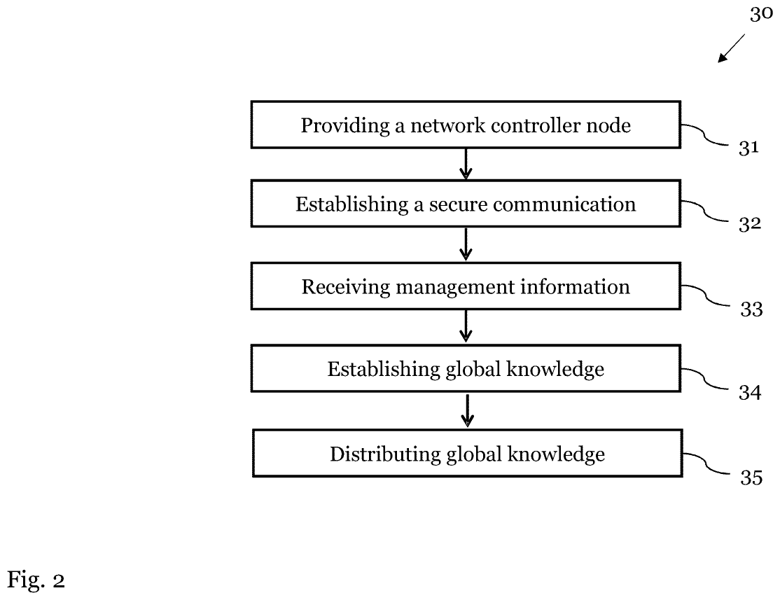

FIG. 2 shows a flow diagram of a method 30 for secure routing in the QKD network according to an embodiment.

The method 30 comprises the steps of: providing 31 the network controller node 10 which comprises the QKD module; establishing 32 the secure communication connection between the network controller node 10 and the at least two routing nodes 21-23 via the KMS layer or the network layer of the QKD network, wherein the at least two routing nodes comprise a respective QKD module and are configured for forwarding information from a number of network entities in the QKD network. The method 30 comprises the further steps of: receiving 33, at the network controller node, management information from the routing nodes 21-23 via the secure communication connection; establishing 34 global knowledge based on the received management information, and distributing 35 the relevant parts of the global knowledge from the network controller node 10 to the respective routing nodes 21-23 via the secure communication connection, wherein the secure communication connection is encrypted using keys provided by the QKD modules.

The method 30 can be carried out by the system 1 as e.g. shown in FIG. 1.

In the following, further exemplary aspects and implementations of the system 1 and the method 30 are discussed:

In general, routing in a communication network can be connection-oriented (C.T. circuit-switching) or connection-less (C.T. packet-switching).

For instance, in a connection-oriented routing, a node sends a request towards a centralized node based on a vector (containing different parameters) and receives a routing path. A connection is established according to this scheme and hold till the message is transmitted. This can be referred to as global routing. Connection-oriented routing typically has the following advantages: reduced delay and latency before and during the transmission; data packet arrives in order with minimum packet loss; and communication is done with a steady bandwidth and consistent data rate. However, connection-oriented routing can have the following disadvantages: it is not well adapted to internet communication; the channel is occupied; and there is a risk of poor use of resources.

In connection-less routing, the nodes can have an own set of rules according to which the routing is performed. The header of each packet can contain information about the routing. For instance, such routing can be established by routing tables. This type of routing has the following advantages: data packets can find the destination without travelling on one dedicated channel; and it allows to send/resend missing or dropped packets (therefore, packet loss is reduced). However, connection-less routing can suffer from higher loss at high traffic loads.

Routing in QKD networks (QKDN) differs greatly from routing in CTN (Classical Telecommunication Networks):
Packet processing: In CTN, packets are processed according to a locally stored routing table to determine the next hop. In QKDN, the routing nodes receive packages that need to be en/decrypted with the respective keys. An increase in the processing pressure on the nodes can be identified.
Forwarding capacity: In CTN, the network bandwidth determines the ability to forward packets. With QKDN, the forwarding capacity also depends on the key generation rate (KGR), the key utilization rate (KUR) and the residual key volume (RKV). Keys related to a link specific demand need to be available.
Routing success rate: Network congestion in the CTN is mainly caused by exceeding the bandwidth and processing capacity of the routing nodes. In the QKDN, congestion can also be caused by an overload depending on the combined bandwidth of the quantum and classical channels. Congestion avoidance begins in the network design.
Traffic dependency: While the traffic in CTN can be assumed independent, the traffic in the key-management layer is dependent on the amount of traffic in the application layer. The key-management layer traffic scales with the KUR. A congestion in the key-management layer can cause a congestion in the application layer. Therefore, traffic engineering is key.
Security: Establishing a secure connection in a CTN is easy, compared to the slow key growing process in QKDN. In operation every message needs to be encrypted and only a minimum amount of metadata is allowed to be leaked.

However, the implementation of the control & management layer in current QKDN is typically realized by a centralized network controller. More precisely, every single network (here, routing-node) node contains a dedicated connection to the SDN controller. A potential eavesdropper positioned in front of the controller, will be provided the same amount of network information as the controller due to the unencrypted traffic, e.g. the status of the nodes and links. Metadata that is to be hidden.

The system 1 as shown in FIG. 1 mitigates these issues by exchanging such messaged via the KMS and/or network layer in an encrypted manner and having the lowest possible information flow (as only a point to point connection can be observed). As a consequence, the topology and network status information are not revealed towards adversaries. Further, metadata such as the number of devices and how often an individual device interacts with the controller is not exposed.

Thereby, the network controller node 10, which can comprise a SDN controller module, can get its own network stack (i.e., QKD module, KMS module, network encryptor module). The at least two routing nodes 21-23 can establish a secure connection to the KMS module of the network controller 10.

The routing between the network controller node 10 and the at least two routing nodes 21-23 of the system 1 to establish the optimized topology can comprise the following steps: (1) gather an initial routing table by all routing nodes 21-23; (2) establish a secure communication with the network controller node 10 (in particular, with the encryptor module of the node 10); (3) receive actual status information (i.e., the management information) from the QKD network with the network controller node 10; (4) use the controller node 10 to calculate an optimal topology (i.e., the global information) and distribute said optimal topology via secure channels; and (5) repeat steps (2)-(3) frequently.

In the following, the steps (1)-(5) of this routing procedure are discussed in more detail:

The initial routing table for establishing the secure connection (step 1) can be established via the network encryptor modules in the network. In private networks this can be realized via pre-shared tables or algorithms (existent in the CTN world).

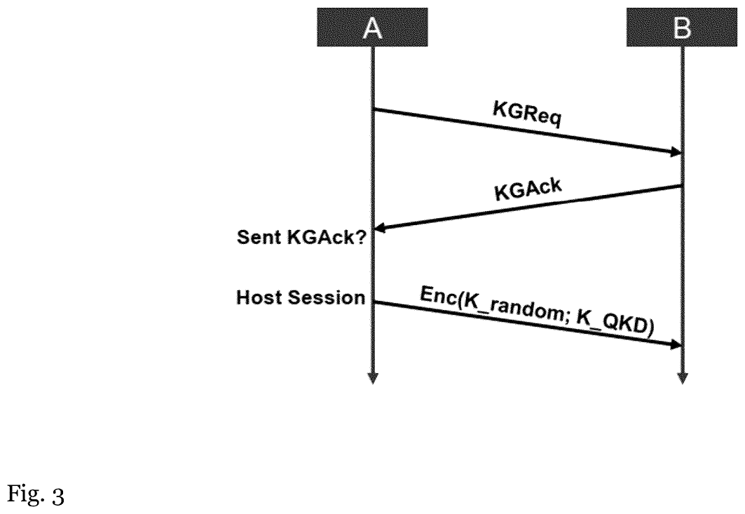

The secure communication with the encryptor node of the network controller node 10 (step 2) can be established via so-called “negotiation of session rights”. The establishment of such a secure communication is schematically depicted in FIG. 3. Thereby, one node A (e.g., the network controller node 10) sends a key generation request “KGReq” to the other node B (e.g., one of the routing nodes 21-23). The other node B sends a key generation acknowledgement “KGAck” in response. The node that previously gets the “Ack” wins, if both nodes A, B receive one they can backup (exp) and redo the battle of rights. In the example, shown in FIG. 3, node A receives the Ack and hosts the session.

During step (3), the routing nodes 21-23 can transmit weights to the network controller node 10 for all links. These messages can be encrypted with the previous established secure channels.

The network controller node 10 can then determine and distribute optimal topology and distribute information to the routing nodes 21-23 (step 4) for establishing an optimal routing strategy. For instance, the network controller node 10 can calculate routing tables globally using a “Shortes-Path”-algorithm and distribute the tables securely via the encrypted channels via the KMS layer (or the network layer).

This routing procedure leads to a number of advantages: The network controller module 10 is “protected” by the KMS layer (similar to a jump-server or DMZ); a routing table can be present in all nodes (especially the routing nodes 21-23); exchanging messages via the KMS layer does not reveal the topology information and further metadata of the QKD network, as the messages are shown to be from the relay node before; for instance, the only way to gather information on the topology is in or before step 1 and user defined; and the network load can be reduced by setting up a number of “main_nodes” for sending state information to remove redundancy.

As discussed above, communication between the network controller node 10 and the routing nodes 21-23 can be carried out via the KMS layer or the network layer.

If the communication is carried out via the KMS layer, the network controller node 10 or its SDN controller module (in the following referred to as: SDNController) can send and receive packets from its KMS module (SDN KMS). As the packets are typically sent via a relay-scheme towards the SDN KMS, the controller node 10 can comprise a standard QKD module.

In this case (communication via KMS layer), the KMS module can be based on a standard KMS module with the following extended functionalities: direct port towards the SDNController; message filter, if SDN is talking towards another KMS module or directly with SDN KMS; and relaying messages if not for itself, else keep. The corresponding KMS modules of the relay nodes 21-23 can encrypt their control messages towards the KMS module of the controller node 10.

If the communication is carried out via the network layer, the SDNController can send and receives packets from its network encryptor module (SDN NE). Other nodes can send messages towards the SDN KMS that establishes a key with these other nodes. The controller node 10 can comprise a standard QKD module and a standard KMS module.

In case of a communication via the network layer, the network encryptor module can be based on a standard network encryptor module with the following extended functionalities: direct port towards the SDNController; message filter, if the SDN controller is talking towards another KMS module or directly with SDN KMS; and relaying messages if not for itself, else keep.

The communication via the network layer can be performed if the key-rate is not sufficient in the KMS layer. The corresponding network encryptor modules of the relay nodes 21-23 can encrypt their control messages towards the SDN NE.

According to a further example, the SDNController sends and receives packets from an underlaying device (which implements the SDNController). The SDNController can thereby: receive a link and connections from every node; select of the most important nodes according to an algorithm (see previous), establish a port to the underlaying device, execute a routing algorithm, establish a possible pre-shared-key connection towards the underlaying device; determine a recalculation time of the ARP tables.

In the following, examples of control-and management architectures are discussed in more detail. Thereby, different exemplary implementations of the CM layer, i.e. how information is transported to and from the CM layer, are shown.

### A. SDN-Enabled QKD Networks

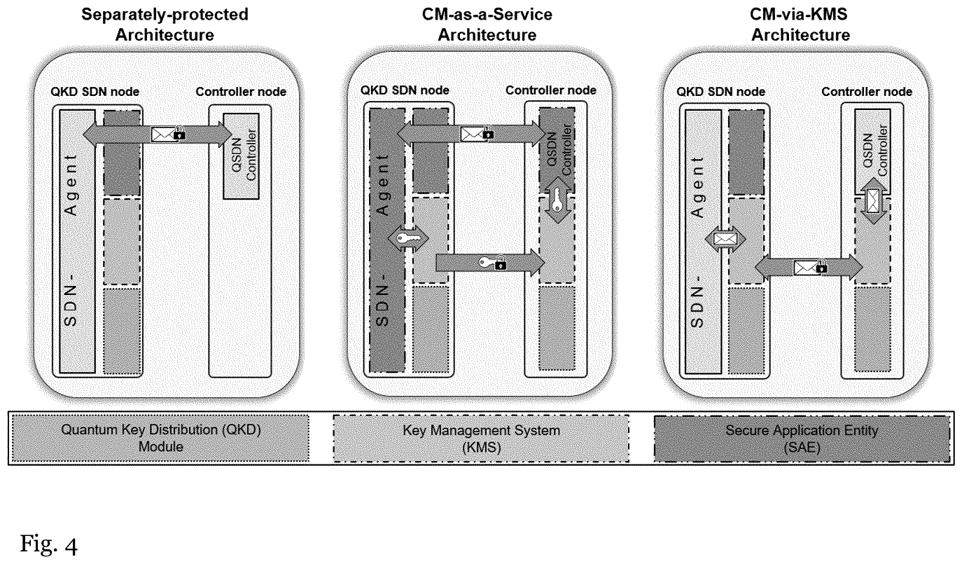

As QKDN can be efficiently enabled by the SDN technology, a central instance can collect and manage information on the network to determine best routing choices, i.e. the QSDN-Controller. The QSDN-Controller is an SDN controller that belongs to the CM layer within the QKDN architecture and is located in a controller node. It exchanges CM information with the SDN-Agent. The SDN-Agent is embedded in the QKD SDN node (QSDN node) and collects or distributes the information from the other network layers. The QSDN node architecture further includes at least one QKD-Module in the quantum layer, a KMS in the KM layer, potentially a network encryptor (NE) or other SAE in the application layer. FIG. 4 depicts three different implementations of the CM layer, i.e. how the controller node receives the CM information from the QSDN nodes and vice versa. Other tasks for establishing a secure key between two distant users using the QKD technology, e.g. the KMS or QKD-Modules, are not shown for sake of simplicity. The following analysis of these three CM architectures concentrates on evaluating their security and performance characteristics. The security aspects are focused to metadata leakage on the network's topology, such as the amount of nodes or infer node activities/priorities by analyzing the frequency of requests from the reactive routing protocol, as well as authentication and Denial-of-Service (DOS) vulnerabilities.

### B. Separately-Protected Architecture

In FIG. 4, a separately-protected (SP) architecture is depicted on the left, illustrating an implementation of the CM layer that utilizes alternative security technologies, rather than QKD, to secure the CM traffic. In this architecture, every node instance has a dedicated connection to the QSDN-Controller, i.e. physical point-to-point connection. The QSDN-Controller, which is solely located in the controller node, exchanges information with the SDN-Agent existent in every network node. In this architecture, the controller node does not attribute a connection to the quantum layer, thereby precluding QKD-secured communication. However, it would be possible to establish an encrypted connection by means of PSK or PQC-algorithms. Therefore, this architecture represents the most ideal performance a CM layer implementation can achieve, as it does not use the QKD technology to secure this traffic which may lead to earlier network congestion due to an increased key consumption.

This architecture offers a significant advantage due to its direct correspondence between the physical and logical architecture. This design is particularly beneficial for implementing routing algorithms that rely on flooding the network with status information, as it either prevents (for every node having an own channel) or reduces (for multiple nodes sharing one channel) this network-flooding. Furthermore, despite the potential challenges of implementing multiple dedicated channels in large-scale networks, this approach provides a highly redundant network topology, ensuring that the QSDN-Controller remains accessible even in the event of a channel failure, thanks to adjacent nodes relaying messages through alternative paths.

In this architecture, a potential eavesdropper positioned in front of the QSDN-Controller may intercept information from the packet headers, as each node maintains a direct connection to the controller. This enables the eavesdropper to collect metadata on the network's topology. Furthermore, the QSDN-Controller is highly exposed and constitutes a single point of failure, making it a favourable target for potential attacks. Proper countermeasures should be put in place. For example, since the CM traffic also contains routing commands, it should at least be authenticated. Respective certificates can be installed and managed in all nodes during the networks lifetime. The controller node, however, may face difficulties in achieving this due to the absence of an interface to the quantum layer.

Relaying data through alternative network interfaces, such as network encryptors or connected SAEs, to the QSDN-Controller, rather than using the network interface of the SDN-Agent itself, necessitates QSDN nodes to interface with the QKDN layer, thereby increasing the layer's utilization. This also includes an increased processing pressure of the devices forwarding the traffic. Another option is to utilize a separate and independent network infrastructure (perhaps an already existent one) that operates in isolation from the QKDN network, such as a 5G network or another carrier network. This approach offers optimal performance, as the CM traffic is handled separately. From a security perspective, it also provides the advantage of being decoupled from the redundancy attribute of the application layer. Nevertheless, again another network infrastructure and-interface is used, hereby increasing the attack surface of the QKDN.

### C. Control-and-Management-as-a-Service Architecture

The architecture shown in the middle of FIG. 4 embodies the control and management as a Service (CMS) architecture. Again, every node holds a dedicated connection to the QSDN-Controller. Compared to the SP architecture, the main difference is that the QSDN-controller attributes a connection to the quantum layer. This enables the nodes to establish a secure channel via the KM layer to the controller node, as the SDN-Agents and the QSDN-Controller are attached as SAE to the respective KMS. Further, this enables an easier authentication of the CM traffic throughout the networks lifetime. Nevertheless, it leaks the same amount of metadata, as the SP architecture and also features a highly exposed network controller that constitutes a single point of failure. Again, appropriate countermeasures should be implemented to mitigate potential risks. As this architecture uses two different network parts of the QKDN, namely the KM network and the application layer, to establish the connection to the controller node, it relies on the redundancy of both parts in the event of a DOS attack. Depending on the topology of the network handling the CM traffic this approach may (as above) be effective for routing protocols that rely on network flooding.

Securing the CM traffic with QKD keys comes with an increased processing pressure in the KM layer as well as with adjustments on the link specific a number of available keys. Dependent on the packet-to-key-ratio, i.e. how often a key is changed in the packet encryption process, the adjustments may also influence the initial design of the QKDN with its components. As in the SP architecture, the CM traffic from the SDN-Agent to the QSDN-Controller can be relayed via an alternative network infrastructure, which (as above) leads to both: an increased attack surface due to the additional network interface and an improved resilience against DoS attacks due to the independent infrastructure.

### D. Control-and-Management-via-KMS Architecture

A CM-via-KMS architecture is shown in FIG. 4 on the right. The system 1 as shown in FIG. 1 may utilize this architecture.

Again, a secure channel is established but without setting the QSDN-Controller and SDN-Agents as SAEs. While CM messages in the CMS architecture are relayed via an alternative management network, messages in this architecture are relayed in the KM layer. More specifically, the messages exchanged with the QSDN-Controller are disseminated throughout the network in a manner analogous to key transports resulting from key requests. Notably, the KMS serves a dual purpose, not only facilitating key transport functions but also forwarding CM traffic received from an internal interface, thereby integrating KM-and CM traffic forwarding capabilities within a single entity. The interface for receiving the CM traffic could be the same as the existent one used for receiving the random-number-generated key, which is used to secure the user traffic.

This approach comes with multiple advantages in terms of security for the KM layer. Firstly, no longer the previous discussed metadata is revealed. An eavesdropper located directly in front of the QSDN-Controller now gains no more information about the metadata than between any other connection in the KM layer, as the traffic is single-hop and point-to-point. Secondly, no additional interface to the application-layer or to the dedicated management network is needed. This approach thus does not result in an expanded attack surface. Further, the use of the KM layer for exchanging CM messages reduces the authentication demands. As a result, when the KM layer provides authentication, the CM layer's authentication is given by design, as CM messages are only relayed between already authenticated/trusted nodes. A last advantage is that sophisticated attacks, such as node-specific DOS attacks are no longer possible, e.g. blocking only the traffic of node A for deflecting another (physical) attack on node B. These security features come at the cost of an increased processing pressure on the nodes located in the KM layer. This is particularly relevant for the gateway node, which is the node, i.e KMS, connecting the controller node to the rest of the QKDN. As the management traffic of every network instance may be relayed by this component, the additional load on the gateway node and the overall KM layer may be investigated. Similar to the CMS architecture, securing the CM traffic with QKD keys increases the processing pressure in the KM layer and the overall key consumption in the QKDN. This processing pressure can be reduced using higher packet-to-key ratios when deploying cryptographic primitives beside One-Time-Pad (OTP). Since the CM traffic is relayed via the KM layer, the robustness against DOS attacks may be contingent upon the KM layer's ability to withstand such attacks. On the other side, an available communication with the QSDN-Controller may be useless if the communication with other KM nodes fails.

This architecture shields the KM layer from metadata exposure as well as by authenticating the CM traffic by its design. This is particularly crucial when the network topologies of the KM layer and the application layer diverge. Further, this protection is essential, as the KM layer is inherently more vulnerable to attacks compared to the application layer.

Summarized, we distinct between three different implementations of the CM layer. Whereas in the SP architecture the missing quantum layer causes authentication and encryption difficulties, the CMS architecture establishes a secure channel to the QSDN-Controller by encrypting it with QKD keys. The new proposed architecture (FIG. 4, right image) relays CM messages in the same manner as a key transport to enhance the security for the KM layer and thus for the network.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the present disclosure may have been disclosed with respect to only one of several implementations, such feature may be combined with one or more other features of the other implementations as may be desired and advantageous for any given or particular application.

What is claimed is:

1. A system for secure routing in a quantum key distribution, QKD, network, comprising:
a network controller node which comprises a QKD module and a key management system, KMS, module; and
at least two routing nodes which comprise a respective QKD module, and which are configured for forwarding information from a number of network entities in the QKD network;
wherein the network controller node is configured to establish a secure communication connection with the at least two routing nodes via a KMS layer or a network layer;
wherein the network controller node is configured to receive management information from the routing nodes via the secure communication connection and to establish global knowledge of the QKD network based on the received management information;
wherein the network controller node is configured to distribute relevant parts of the global knowledge to the respective routing nodes via the secure communication connection;
wherein the secure communication connection is encrypted using keys provided by the QKD modules.

2. The system of claim 1,
wherein, if the secure communication connection is established via the network layer, the keys are established from the KMS layer which receives the keys from the QKD modules.

3. The system of claim 1,
wherein the network controller node and/or the at least two routing nodes comprise a respective KMS module which is configured to interact with the KMS layer.

4. The system of claim 3,
wherein the respective KMS module of the routing nodes is configured to determine if a data packet was generated by itself or received from another node, and not to decrypt the data packet if the data packet was generated by itself.

5. The system of claim 1,
wherein the network controller node and/or the at least two routing nodes are configured to establish a new key from the network layer if they detect that there is an insufficient number of keys.

6. The system of claim 1,
wherein the network controller node and/or the at least two routing nodes comprise a respective secure application entity, SAE, which is configured to interact with the network layer.

7. The system of claim 1,
wherein the management information comprises status information and/or channel information from the routing nodes.

8. The system of claim 1,
wherein the global knowledge comprises an optimal network topology and/or configuration for a routing operation in the QKD network.

9. The system of claim 1,
wherein the at least two routing nodes comprise a respective initial routing table which is updated and/or adapted based on the relevant parts of the global knowledge.

10. A method for secure routing in a quantum key distribution, QKD, network, comprising:
providing a network controller node which comprises a QKD module and a key management system, KMS, module;
establishing a secure communication connection between the network controller node and at least two routing nodes via a KMS layer or a network layer, wherein the at least two routing nodes comprise a respective QKD module and are configured for forwarding information from a number of network entities in the QKD network;
receiving, at the network controller node, management information from the routing nodes via the secure communication connection;
establishing global knowledge of the QKD network based on the received management information; and
distributing relevant parts of the global knowledge from the network controller node to the respective routing nodes via the secure communication connection;
wherein the secure communication connection is encrypted using keys provided by the QKD modules.

11. The method of claim 10,
wherein, if the secure communication connection is established via the network layer, the keys are established from the KMS layer which receives the keys from the QKD modules.

12. The method of claim 10,
wherein the network controller node and/or the at least two routing nodes comprise a respective KMS module which is configured to interact with the KMS layer.

13. The method of claim 12,
wherein the respective KMS module of the routing nodes is configured to determine if a data packet was generated by itself or received from another node, and not to decrypt the data packet if the data packet was generated by itself.

14. The method of claim 10,
wherein the network controller node and/or the at least two routing nodes are configured to establish a new key from the network layer if they detect that there is an insufficient number of keys.

15. The method of claim 10,
wherein the network controller node and/or the at least two routing nodes comprise a respective secure application entity, SAE, which is configured to interact with the network layer.

16. The method of claim 10,
wherein the management information comprises status information and/or channel information from the routing nodes.

17. The method of claim 10,
wherein the global knowledge comprises an optimal network topology and/or configuration for a routing operation in the QKD network.

18. The method of claim 10,
wherein the at least two routing nodes comprise a respective initial routing table which is updated and/or adapted based on the relevant parts of the global knowledge.
